(19) United States
(12) Patent Application Publication
(10) Pub. No.: US 2016/0036280 A1
(43) Pub. Date: Feb. 4, 2016

(54) STATOR OF AN ELECTRICAL MACHINE PROVIDED WITH SHEATHS WITH AN OPTIMISED LENGTH FOR INSULATION OF THE WIRES WHICH ARE CONNECTED TO THE COILS, AND CORRESPONDING ELECTRICAL MACHINE

(71) Applicant: VALEO EQUIPEMENTS ELECTRIQUES MOTEUR, Creteil Cedex (FR)

(72) Inventors: Jean-Claude MATT, Dijon (FR); Benoit WALME, Feucherolles (FR)

(21) Appl. No.: 14/777,290

(22) PCT Filed: Apr. 22, 2014
(86) PCT No.: PCT/FR2014/050969

§ 371 Date: Sep. 15, 2015

(30) Foreign Application Priority Data
Apr. 23, 2013 (FR) 1353682

(51) Int. Cl. H02K 3/28; H02K 3/38

(52) U.S. Cl. CPC H02K 3/28; H02K 3/38

(57) ABSTRACT

A stator for a multiphase rotary electric machine comprising a set of coils wound around teeth of the stator. The coil inputs are interconnected with other inputs, forming the neutral point and the coil outputs are interconnected with other outputs, forming one of the phases. Each phase is associated with a bundle of wires. Two bundle portions run around part of the circumference of the stator, connecting the outputs that make up the same phase. The stator comprises a set of insulating sheets protecting the wires. Each bundle is divided in a dividing zone near a connection of one or more bundles with an output of one coil belonging to the phase corresponding to said bundle. The insulating sheets extend around the circumference of the stator to an output of a next coil of a phase or between the outputs of two successive coils.

### TECHNICAL FIELD OF THE INVENTION

The invention relates to a stator of an electrical machine provided with sheaths with an optimised length for insulation of the wires which are connected to the coils, as well as to the corresponding electrical machine. The invention has a particularly advantageous application in the field of rotary electrical machines such as an alternator or electric motor. The invention can advantageously be used with a compressor for air-conditioning coolant fluid for a motor vehicle.

### PRIOR ART

Electrical machines are known comprising a stator and a rotor integral with a shaft which ensures the movement of a spiral compressor, which is also known as a scroll compressor. A system of this type comprises two spirals which are interpenetrating as vanes in order to pump and compress the coolant fluid. In general, one of the spirals is fixed, whereas the other one is displaced eccentrically without rotating, such as to pump, then trap and compress pockets of fluid between the spirals. A system of this type is described for example in document EP1865200.

The stator comprises a body which is made of laminated plate in order to reduce the Foucault currents. The body has on its outer periphery an annular wall, known as a head, and teeth which are obtained from the inner periphery of the annular wall, with an outer periphery which is in contact with a housing which the rotary electrical machine comprises. This housing, which is also known as a casing, is configured to rotate the rotor shaft by means of ball bearings and/or needle bearings, as can be seen for example in FIGS. 1 and 2 of document EP 1865200.

The teeth of the stator are distributed on the wall of the stator body, and extend towards the interior of the stator in the direction of the rotor. An air gap extends between the free end of the teeth, defining the inner periphery of the stator body and the outer periphery of the rotor, which can be a rotor with permanent magnets. The teeth define together with the annular wall notches which are open towards the interior, and are designed to receive windings, for example in the form of coils, for formation of a polyphase stator, for example of the three-phase type.

Coils which are insulated electrically against the stator body are wound around teeth such that each notch of the stator receives two half-coils. The coils can be insulated against the stator body by using insulating elements which are placed on both sides of the stator body in combination with notch insulators which are positioned against the inner walls of the notches. It is also possible to use coils fitted on individual insulating supports which are designed to be fitted around a tooth of the stator via an opening which is provided in the support.

Each coil comprises and input an and output comprising one or a plurality of wires in parallel. The input is designed to be interconnected with other inputs, in order to constitute the neutral point of the electrical machine, whereas the output is designed to be interconnected with other outputs of the coils, in order to form one of the phases of the machine.

FIG. 1 shows a stator 1 comprising three phases U, V, W, and fifteen coils 2, i.e. five coils per phase. Each phase U, V, W is associated with a bundle of wires which run around almost all of the circumference of the stator, in order to connect the various coils which belong to the corresponding phase.

With the phase U being formed by the five outputs of coils U1-U5, FIG. 1 represents the paths C1-C4 travelled by the various insulating sheaths 3 of the wires of the bundle FU which are connected to the outputs U2-U5, in the knowledge that another wire of the bundle is connected to the output U1. These insulating sheaths 3 makes it possible to prevent the mechanical friction of the copper wires on the chignons of the coils 2. It will be remembered that the chignons are formed by the parts of the coils 2 which extend projecting on both sides of the stator 1 body.

The disadvantage of this configuration consists in particular in the fact that the wires of the bundle FU need different sheath lengths in order to be connected to the outputs of the corresponding coils, which complicates the assembly process and makes it very lengthy.

In addition, the total height of the stator is not optimised. In fact, the thickness of the insulating sheaths is greater in the area ZA of connection to the first coils, in which all the sheaths are present, then in the area ZB of connection to the final coils, in which only some sheaths are present.

It can also be noted that in the case of a compressor, the passage of the fluid which circulates inside the stator can be impeded by the set of sheaths which cover a large surface area of the end face of the stator in the area ZA of connection to the first coils.

### SUBJECT OF THE INVENTION

The object of the invention is to eliminate efficiently at least one of these disadvantages by proposing a stator for a polyphase rotary electrical machine comprising a body which is provided with an outer wall and teeth which extend from an inner periphery of the said outer wall towards the interior of the stator,

a set of coils wound around teeth which each have an input and output comprising one or a plurality of wires in parallel, the input being designed to be interconnected with other inputs in order to constitute the neutral point of the machine, and the output being designed to be interconnected with other outputs in order to form one of the phases of the machine, and,
each phase is associated with a bundle of wires, this bundle being separated into two portions of bundle, these two portions of bundle running along part of the circumference of the stator according to two opposite directions in order to connect the outputs of the coils which form a single phase, and
a set of insulating sheaths which protect the wires of each portion of bundle, characterised in that
each bundle is separated in a separation area which is situated in the vicinity of a connection of one or a plurality of wires of the bundle to an output of one of the coils belonging to the phase corresponding to the said bundle, such that the insulating sheaths which extend according to the circumference of the stator, from the area of separation to an output of the next coil of a phase, or between the outputs of two successive coils of the said phase, all have a length substantially identical to one another.

Since all the insulating sheaths have the same length on the circumference of the stator, it is possible to standardise the sheaths, which will make it possible to reduce the duration of assembly of the stator. In addition, since the thickness of the insulating sheaths is substantially constant over all of the circumference of the stator, taking into account the configuration of the portions of bundle, the invention makes it possible to reduce the final height of the stator. It can also be noted that the surface area which is covered by the sheaths on the outer periphery of the chignon is minimised, which makes it possible to obtain a better flow of the coolant fluid in the case of a machine of the compressor type.

According to one embodiment, for a set of sheaths corresponding to a single portion of bundle, each sheath protects a different number of wires, this number of wires decreasing by the number of wires in parallel in a coil between two adjacent sheaths, when displacement takes place from the area of separation, towards the sheath of the portion of bundle which is furthest from the area of separation.

According to one embodiment, the neutral point is produced by connecting to one another the inputs of M successive coils at interconnection points, M being the number of phases of the electrical machine.

According to one embodiment, the interconnection points are connected to one another.

According to one embodiment, the stator comprises two insulating elements which are placed on both sides of the stator, each comprising a support which is designed to be placed against the wall of the stator, and arms which are derived from an inner periphery of the support, and are designed to be placed against the teeth of the stator, the coils being wound around the assembly formed by the teeth of the stator and the arms of the insulating elements.

According to one embodiment, one of the insulating elements comprises anchorage systems which can retain an input or an output of the coils during a winding operation.

According to one embodiment, each anchorage system is formed by a hook which faces towards an outer periphery of the support.

According to one embodiment, one of the insulating elements comprises systems for retention of the insulating sheaths.

According to one embodiment, each system for retention of the insulating sheaths is formed by a base with axial extension, and a projecting tongue derived from a face of the base which faces towards the exterior of the support.

According to one embodiment, the stator additionally comprises notch insulators which are placed against inner walls of notches delimited by the teeth of the stator.

The invention also relates to a rotary electrical machine with 2p rotor poles and M phases provided with a stator according to the invention comprising M times p coils.

### BRIEF DESCRIPTION OF THE FIGURES

The invention will be better understood by reading the following description and examining the accompanying figures. The figures are provided purely by way of illustration of the invention which is in no way limiting.

FIG. 1, already described, is a plan view of a stator wound according to the prior art, showing the paths of the various insulating sheaths which protect the wires connected to the outputs of the coils which form a single phase;

FIG. 2 shows a view in perspective of a stator for an electrical machine according to the invention;

FIG. 3 shows an exploded view of the various elements which constitute the stator according to the invention represented without the winding;

FIG. 4 shows a diagram of the electrical connections to one another of the coils of the stator according to the invention;

FIG. 5a shows a schematic representation of the configuration of the connections of the wires of a bundle at the outputs of the coils which form a single phase U;

FIG. 5b shows a schematic representation similar to that of FIG. 5a, but without the coils, and with the positioning of the outputs of the said coils on the circumference of the stator;

FIG. 6 shows a plan view of the stator, showing the groupings of the various inputs of the coils for production of the neutral point of the electrical machine;

FIG. 7 is a plan view of stator wound according to the invention showing the paths of the various insulating sheaths which protect the wires of the outputs of the coils which form a single phase.

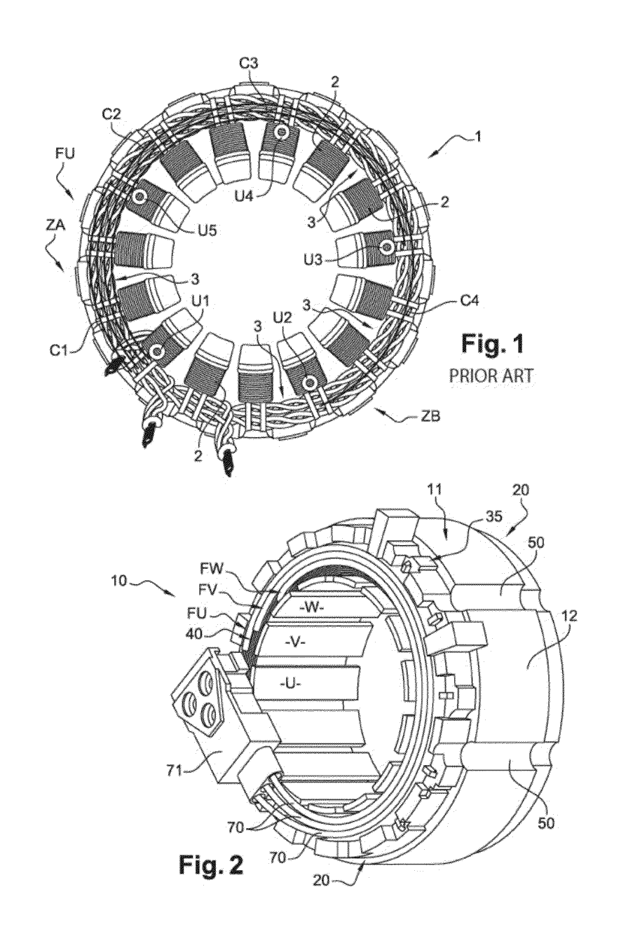

Elements which are identical, similar or analogous retain the same reference from one figure to the next.

### DESCRIPTION OF EMBODIMENTS OF THE INVENTION

FIGS. 2, 3, 6 and 7 show a stator 10 of a rotary electrical machine such as a compressor for air-conditioning coolant fluid for a motor vehicle. As a variant, the machine consists of an alternator or an electric motor.

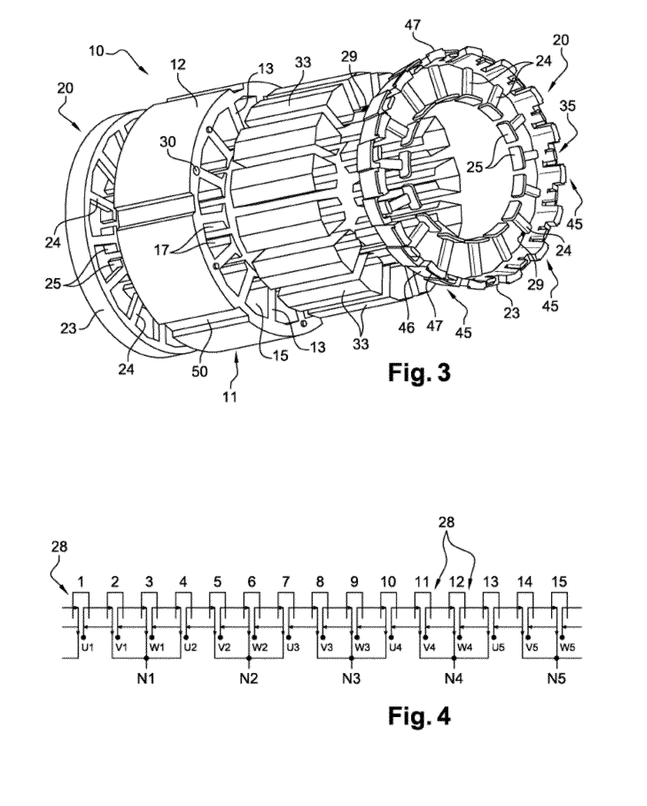

As can be seen clearly in FIG. 3, this stator 10 comprises a body 11 in the form of a set of laminated plates with an annular wall 12 known as a head on its outer periphery and teeth 13 derived from the inner periphery of the annular wall 12. These teeth 13 are distributed circumferentially regularly and extend towards the interior in the direction of the rotor of the machine, such as a rotor with permanent magnets. The teeth 13 delimit in pairs notches 15, two successive notches 15 thus being separated by a tooth 13. These teeth 13 have on their free end returns 17 which extend circumferentially on both sides of the tooth 13. The free ends of the teeth 13 delimit in a known manner an air gap with the outer periphery of the rotor of the rotary electrical machine.

Two electrically insulating elements 20 are placed on both sides of the stator 10, on its radial end faces. Each element 20 can be made of mouldable plastic material, for example PA 6.6. Each element 20 made of plastic material can if applicable be reinforced by fibres, such as glass fibres.

Each insulating element 20 comprises on its outer periphery a support 23 in the form of a ring with axial orientation, and arms 24 which are distributed circumferentially, and extend radially from the inner periphery of the support 23 towards the interior of the element 20. These arms 24 each end at their free end in a rim 25 which makes it possible to retain in the radial direction coils 28 which belong to the excitation winding described hereinafter. The arms 24 are distributed regularly on the inner periphery of the support 23, and are designed to be supported against teeth 13 of the stator with a corresponding form. The support 23 is designed to be placed against the head 12 of the body 11 of the stator. In this case, there are fifteen arms 24 of the insulating elements, as well as fifteen teeth 13.

The insulating elements 20 can be retained by means of two snapping-in (clipping) devices 29 which are shown in FIG. 3, and can cooperate with openings 30 provided in the corresponding end face of the stator 10.

In addition, the stator 10 is equipped with notch insulators 33 in the form of a fine membrane, made of a material which is electrically insulating and conducts heat, for example an aramid material of the type known as Nomex (registered trademark). This fine membrane is folded such that each notch insulator 33 is placed against the inner walls of the notches 15 in the stator 10.

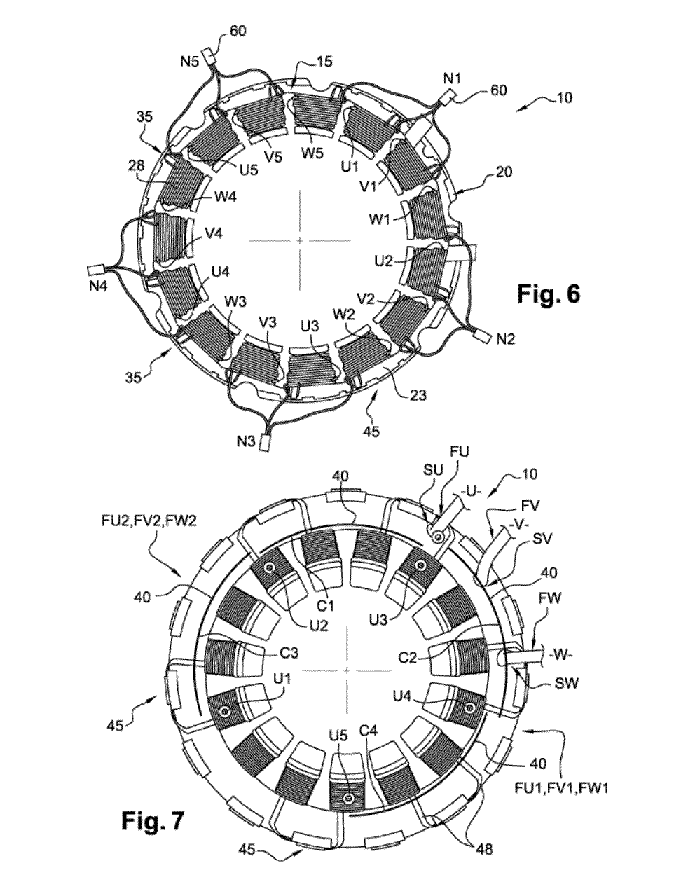

The wires of the coils 28 which can be seen clearly in FIG. 6, such as copper or aluminium wires covered with an electrically insulating layer such as enamel, are each wound around a tooth 13 and associated arms 24 of the insulating elements 20, in order to form the various poles of the stator 10. This winding operation can be carried out for example by means of a needle which is hollow in the centre in order to permit passage of one or a plurality of wires in parallel which form the coil. This needle is displaced circumferentially, axially and radially relative to the stator. The winding is preferably carried out in the anticlockwise direction. Thus, the arms 24 of the insulating elements 20 and the notch insulator 33 insulate the coils 28 of the winding of the stator 10 against the set of plates of the stator 10, and protect them during the winding operation.

In order to facilitate the winding operation, one of the insulating elements 20 preferably comprises anchorage systems 35 which make it possible to retain in position an end of one or a plurality of wires which form each coil 28, corresponding to an input or an output of the coil 28. Each anchorage system 35 is for example formed by a hook which faces towards the outer periphery of the support 23, as shown in FIGS. 2 and 6. This hook permits the passage of an end of one or a plurality of wires of a coil 28 between a lug which forms a return of the said hook, and the outer surface of the support 23 which is situated on the side opposite the stator. Alternatively, as shown in FIG. 3, the anchorage system 35 comprises a pin and a groove in the form of a “U” provided around the pin, inside which there is positioned the end of one or a plurality of wires supported against the lateral walls of the pin for its retention.

The winding is carried out such that a single notch 15 receives two half coils 28. Each coil 28 has two projecting parts, known as chignons, which are disposed on both sides of a tooth 13 of the stator. In this case, the coils 28 have a trapezoidal form, as can be seen clearly in FIG. 6.

The coils 28 each have an input and an output comprising a single wire or a plurality of wires in parallel. In fact, this depends on the number of wires from which the coil has been produced. The input is designed to be interconnected with other inputs, in order to form the neutral point of the electrical machine. The output is designed to be interconnected with other outputs, in order to form one of the phases of the machine. The input preferably corresponds to the end which is retained by the anchorage system 35 during the winding operation. This is illustrated in FIG. 6 for coils formed from a single wire. As can be seen clearly in FIG. 4, for an electrical machine with three phases U, V, W provided with a stator comprising fifteen coils 28 numbered from 1 to 15, each phase U, V, W is formed by five coils 28. More generally, for a machine with 2p rotor poles and M phases, the stator comprises M times p coils.

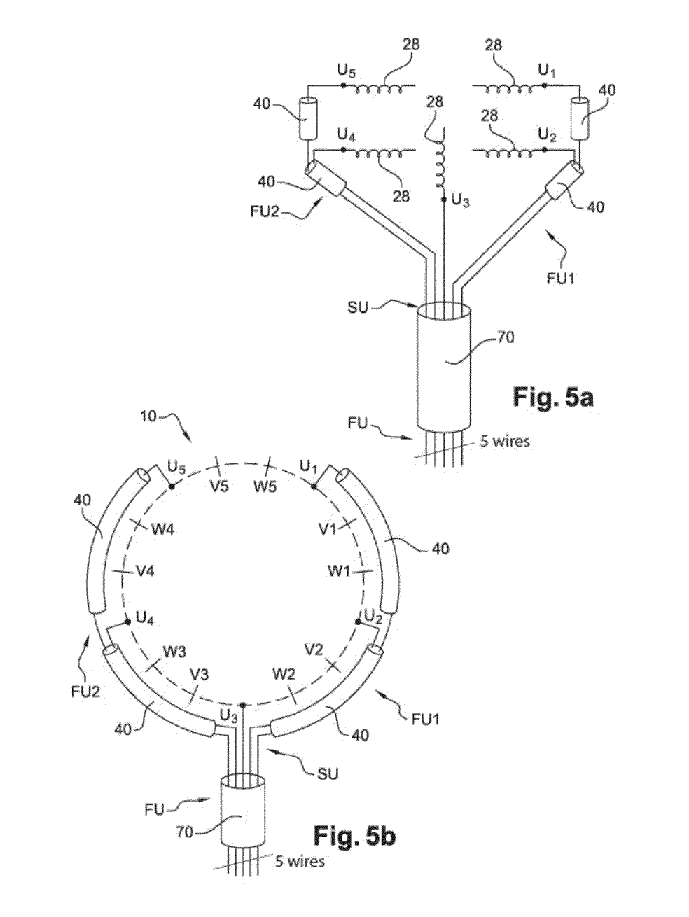

It can be noted that the outputs of the coils 28 which are coupled in parallel are connected alternately to the different phases of the machine. Thus, for three successive coils 28, the output of the first coil 28 is connected to one of the phases, for example the phase U, the output of the second coil 28 is connected to another phase, for example the phase V, and the output of the third coil 28 is connected to the final phase W, and so on for all of the coils of the stator 10. The references Ui thus correspond to the outputs of the coils i connected to the phase U, the references Vj correspond to the outputs of the coils j connected to the phase V, whereas the references Wk correspond to the outputs of the coils k connected to the phase W. It can be noted that the angular step PA between the coils 28 which belong to a single phase is constant (cf. FIG. 5b). Angular step PA means the angle of separation between two outputs of consecutive coils 28 of a single phase. The angular step can also be constant from one phase to another. For each phase, this angular step is equal to 360 divided by the number of coils for the said phase, i.e. in this case with an identical number of five coils for each of the phases 360/5=72°.

In addition, the neutral point of the electrical machine is produced by connecting the inputs of successive coils M to one another at interconnection points, M being the number of phases. As can be seen clearly in FIGS. 4 and 6, the inputs of the coils 28 are thus grouped in groups of three into 15/3=5 interconnection points N1-N5. As can be seen in FIG. 6, the interconnection points N1-N5 can each be physically constituted by a metal tube 60, to which the inputs of the coils 28 are connected in groups of three. It can be noted that the interconnection points N1-N5 can or need not be connected to one another.

Each phase U, V, W, is associated with a bundle FU, FV, FW of wires separated into two portions of bundles (FU1, FU2); (FV1, FV2) or (FW1, FW2). Each bundle FU, FV, FW is separated in a separation area SU, SV, SW situated in the vicinity, for example just above, of a connection of one or a plurality of wires of the bundle to an output of one of the coils 28 which belongs to the phase corresponding to the said bundle FU, FV, FW. For example for the phase U, from the area of separation SU (situated in the vicinity of the output U3), the next coils 28 following the circumference of the stator are connected respectively by the outputs U2 and U4. For the phase U, two successive coils 28 following the circumference of the stator are connected respectively by the outputs U3 and U4, U4 and U5, U3 and U2, or U2 and U1.

Similarly, for the phase V, from the area of separation SV (situated in the vicinity of the output V3), the next coils 28 following the circumference of the stator are connected respectively by the outputs V2 and V4. For the phase V, two successive coils 28 following the circumference of the stator are connected respectively by the outputs V3 and V4, V4 and V5, V3 and V2, or V2 and V1.

Finally for the phase W, from the area of separation SW (situated in the vicinity of the output W3), the next coils 28 following the circumference of the stator are connected respectively by the outputs W2 and W4. For the phase W, two successive coils 28 following the circumference of the stator are connected respectively by the outputs W3 and W4, W4 and W5, W3 and W2, or W2 and W1.

The portions of bundles run along part of the circumference of the stator according to two opposite directions, in order to connect the outputs Ui, Vj or Wk of the coils 28 which form a single phase. The number of wires of each portion of a bundle is reduced by the number of wires in parallel in a coil after each connection to an output Ui, Vj, Wk of a coil 28, when there is displacement from the area of separation SU, SV, SW towards a final coil 28 which is connected by its output to the corresponding portion of bundle. For example, if the coil 28 is formed from one wire, as is the case in FIGS. 5a and 5b, the number of wires of the portion of bundle is reduced by one after each connection to a coil output. In the case when the coil 28 is formed from three wires in parallel, the number of wires in the portion of bundle is reduced by three after each connection to a coil output. Each portion of bundle FU1, FU2; FV1, FV2; FW1, FW2 comprises at the area of separation SU, SV, SW a number of wires equal to the number of wires of the bundle FU, FV, FW less the number of wires in parallel in a coil, all being divided by two. In fact, since the stator runs from the areas of separation SU, SV, SW according to the two opposite directions, there is an equal number of coils, and the number of wires between the two portions (FU1, FU2), (FV1, FV2), (FW1, FW2) is equal.

As represented in FIGS. 5a and 5b, for the stator 10 with three phases each formed by five coils 28 each formed by a wire, the bundle FU of the phase U which comprises five wires has a wire which is connected to an output U3 of a coil 28. This bundle FU is subdivided into two portions of bundle FU1, FU2 in an area of separation SU situated in the vicinity of the connection to the output U3. Each portion of bundle FU1, FU2 comprises two wires, then a wire after the connection to an output U2, U4 of one of the coils. The final wires of each portion of bundle FU1, FU2 are connected respectively to the outputs U1 and U5 of the final coils 28. In the case when the number of coils 28 which forms a phase is even, the bundle FU, FV, FW will be separated in the area which is situated in the vicinity of the connection to one of the coils of the phase, the number of wires of each portion of bundle then being different.

In addition, insulating sheaths 40 which protect the wires of each portion of bundle FU1, FU2; FV1, FV2; FW1, FW2 extend between the outputs Ui, Vj, Wk of two successive coils 28 which belong to the same phase U, V, W. For a set of sheaths 40 corresponding to a single portion of bundle FU1, FU2; FV1, FV2; FW1, FW2 each sheath 40 protects a different number of wires. In fact, this number of wires is decreased by the number of wires in parallel in a coil between two adjacent sheaths 40, when displacement takes place from the area of separation SU, SV, SW towards the sheath of the corresponding portion of bundle which is furthest from the area of separation SU, SV, SW. This characteristic is associated with the connection configuration of the wires of the portions of bundle FU1, FU2; FV1, FV2; FW1, FW2 previously described. In addition, since the angular step PA between the coils is constant in the same phase as well as from one phase to another, the insulating sheaths 40 all have a length which is substantially identical to one another.

Thus, as shown in FIGS. 5a and 5b, use is made of four insulating sheaths 40 in order to protect the wires of the two portions of bundle FU1, FU2, i.e. two sheaths 40 per portion of bundle FU1, FU2. For each portion of bundle FU1, FU2, the insulating sheath 40 which is closest to the area of separation SU protects two wires, whilst the insulating sheath 40 which is furthest from the area of separation SU protects a single wire. It will be noted that these four sheaths 40 which can be seen in FIG. 7 run substantially along the same circumferential parts, such that they all have a length which is substantially identical. The same applies to the insulating sheaths 40 which protect the wires of the portions of bundles FV1, FV2; FW1, FW2 corresponding to the other phases V, W.

It will be noted that the ends of the bundles FU, FV, FW are sheathed by tubes 70 which can be seen in FIGS. 2, 5a and 5b, and can be contracted around the wires by heating. This therefore forms projecting ends which are connected to a connector 71 (cf. FIG. 2) which is designed to be put into relationship with an inverter, as described for example in document EP0831580 to which reference will be made for further details.

As can be seen clearly in FIGS. 3 and 6 in particular, the insulating element 20 which supports the anchorage systems 35 also preferably comprises systems 45 for retention of the insulating sheaths 40. These systems 45 are interposed between two successive anchorage systems 35. In order to retain the insulating sheaths 40, each retention system 45 comprises a base 46 with axial extension and a projecting tongue 47 derived from a face of the base 46 which faces towards the exterior of the support 23.

In order to retain the insulating sheaths 40 in position, retention wires 48 which can be seen in FIG. 7 are supported against a face of the tongue 47. The retention wires 48 are also supported against the lateral faces of the base 46, and pass above the insulating sheaths 40 and below chignons of the stator, such as to keep the insulating sheaths 40 placed against the chignons of the coils 28.

For a compressor, the rotor of the electric motor of the compressor (not represented) has permanent magnets which are positioned inside the rotor. The magnets can have radial orientation. In this embodiment, the rotor comprises a body in the form of a set of plates provided with receptacles, which can have radial orientation for accommodation of the magnets. The rotor body can comprise a central core, and teeth which extend radially relative to the core. These teeth each comprise two rims which extend circumferentially on both sides of the teeth. Permanent magnets are positioned inside receptacles which are each delimited by two faces opposite one another of two adjacent teeth, an outer face of the rotor core, and the rims of the teeth.

As is apparent from the drawings, and in particular FIGS. 2 and 3, the positioning of recesses 50 provided in the outer periphery of the stator body 11, as well as in the insulating elements 20, corresponds to the angular positioning of openings provided in closure flanges of the machine, thus ensuring the passage of the assembly tie rods, with the said flanges belonging to a housing which supports the stator body.

More specifically, in a known manner, this housing comprises three parts, i.e. an intermediate part which supports the annular wall 12 of the stator 10 of the electrical machine, such as a compressor for air-conditioning coolant fluid for a motor vehicle, and two flanges which are disposed on both sides of the intermediate part. One of these flanges with a hollow form supports the scroll of the compressor, whereas the other flange supports the control electronics of the compressor. The tie rods, for example in the form of screws, connect the flanges to one another by passing through the recesses 50 in the stator, which is for example fitted by bracing via its annular wall 12 in the intermediate part sandwiched between the flanges.

Advantageously, the intermediate part comprises bracing sectors for fitting by bracing of the wall 12 of the stator 10. Between two consecutive bracing sectors there are passages. These passages are opposite recesses 50. The outer periphery of the wall 12 is in bracing contact with the inner periphery of the bracing sectors. The passages are opposite recesses 50, such that the tie rods pass through the passages without interfering with the intermediate part of the housing. The intermediate part can be filled with coolant liquid. This fluid can easily pass through the spaces between the coils 28 and the insulating sheaths, taking into account the reduced radial size of the insulating sheaths 40 on the end face of the stator 10.

The set of plates of the rotor can be integral with a shaft, which itself is integral with the movable scroll of the compressor. In this embodiment, the compressor is without a pulley, and the control electronics of the electric motor are integral with a flange, whilst being integrated in the compressor.

As an alternative, in order to insulate the coils 28 against the set of plates of the stator 10, use is made of the individual insulating supports, not represented, which are designed to be fitted around a tooth 13 of the stator 10 via an opening provided in each insulating support. If applicable the coils 28 are wound around the insulating supports before positioning the individual insulating supports around the teeth 13 of the stator 10.

1. Stator (10) for a polyphaser rotary electrical machine comprising a body (11) which is provided with an outer wall (12) and teeth (13) which extend from an inner periphery of said outer wall (12) towards the interior of the stator (10),
a set of coils (28) wound around teeth (13) which each have an input and output comprising one or a plurality of wires in parallel, the input being designed to be interconnected with other inputs in order to constitute the neutral point of the machine, and the output being designed to be interconnected with other outputs in order to form one of the phases (U, V, W) of the machine, and,
each phase (U, V, W) is associated with a bundle of wires (FU, FV, FW), this bundle (FU, FV, FW) being separated into two portions of bundle (FU1, FU2, FV1, FV2, FW1, FW2), these two portions of bundle running along part of the circumference of the stator (10) according to two opposite directions in order to connect the outputs of the coils (28) which form a single phase, and
a set of insulating sheaths (40) which protect the wires of each portion of bundle (FU1, FU2, FV1, FV2, FW1, FW2),
wherein
each bundle (FU, FV, FW) is separated in a separation area (SU, SV, SW) which is situated in the vicinity of a connection of one or a plurality of wires of the bundle (FU, FV, FW) to an output (U3, V3, W3) of one of the coils (28) belonging to the phase corresponding to said bundle, such that the insulating sheaths (40) which extend according to the circumference of the stator (10), from the area of separation (SU, SV, SW) to an output (U2, U4, V2, V4, W2, W4) of the next coil (28) of a phase (U, V, W), or between the outputs of two successive coils (28) of said phase, all have a length substantially identical to one another.

2. Stator according to claim 1, characterised in that, for a set of sheaths (40) corresponding to a single portion of bundle (FU1, FU2; FV1, FV2; FW1, FW2), each sheath (40) protects a different number of wires, this number of wires decreasing by the number of wires in parallel in a coil between two adjacent sheaths, when displacement takes place from the area of separation (SU, SV, SW), towards the sheath of the portion of bundle which is furthest from the area of separation.

3. Stator according to claim 1, characterised in that the neutral point is produced by connecting to one another the inputs of M successive coils at interconnection points (N1-N5), M being the number of phases of the electrical machine.

4. Stator according to claim 3, characterised in that the interconnection points (N1-N5) are connected to one another.

5. Stator according to claim 1, characterised in that it comprises two insulating elements (20) which are placed on both sides of the stator (10), each comprising a support (23) which is designed to be placed against the wall (12) of the stator (10), and arms (24) which are derived from an inner periphery of the support (23), and are designed to be placed against the teeth (13) of the stator (10), the coils (28) being wound around the assembly formed by the teeth (13) of the stator and the arms (24) of the insulating elements.

6. Stator according to claim 5, characterised in that one of the insulating elements comprises anchorage systems which can retain an input or an output of the coils during a winding operation.

7. Stator according to claim 6, characterised in that each anchorage system (35) is formed by a hook which faces towards an outer periphery of the support (23).

8. Stator according to claim 5, characterised in that one of the insulating elements (20) comprises systems (45) for retention of the insulating sheaths (40).

9. Stator according to claim 8, characterised in that each system (45) for retention of the insulating sheaths is formed by a base (46) with axial extension, and a projecting tongue (47) derived from a face of the base (46) which faces towards the exterior of the support.

10. Stator according to claim 1, characterised in that it additionally comprises notch insulators (33) which are placed against inner walls of notches (15) delimited by the teeth (13) of the stator.

11. Rotary electrical machine with 2p rotor poles and M phases provided with a stator (10) according to claim 1 comprising M times p coils.

12. Stator according to claim 2, characterised in that the neutral point is produced by connecting to one another the inputs of M successive coils at interconnection points (N1-N5), M being the number of phases of the electrical machine.

13. Stator according to claim 2, characterised in that it comprises two insulating elements (20) which are placed on both sides of the stator (10), each comprising a support (23) which is designed to be placed against the wall (12) of the stator (10), and arms (24) which are derived from an inner periphery of the support (23), and are designed to be placed against the teeth (13) of the stator (10), the coils (28) being wound around the assembly formed by the teeth (13) of the stator and the arms (24) of the insulating elements.

14. Stator according to claim 3, characterised in that it comprises two insulating elements (20) which are placed on both sides of the stator (10), each comprising a support (23) which is designed to be placed against the wall (12) of the stator (10), and arms (24) which are derived from an inner periphery of the support (23), and are designed to be placed against the teeth (13) of the stator (10), the coils (28) being wound around the assembly formed by the teeth (13) of the stator and the arms (24) of the insulating elements.

15. Stator according to claim 4, characterised in that it comprises two insulating elements (20) which are placed on both sides of the stator (10), each comprising a support (23) which is designed to be placed against the wall (12) of the stator (10), and arms (24) which are derived from an inner periphery of the support (23), and are designed to be placed against the teeth (13) of the stator (10), the coils (28) being wound around the assembly formed by the teeth (13) of the stator and the arms (24) of the insulating elements.

16. Stator according to claim 6, characterised in that one of the insulating elements (20) comprises systems (45) for retention of the insulating sheaths (40).

17. Stator according to claim 7, characterised in that one of the insulating elements (20) comprises systems (45) for retention of the insulating sheaths (40).
